(19) United States
(12) Patent Application Publication
(10) Pub. No.: US 2025/0180062 A1
(43) Pub. Date: Jun. 5, 2025

(54) SPRING CLIP

(71) Applicant: J. VAN WALRAVEN HOLDING B.V., MIJDRECHT (NL)

(72) Inventors: Marek JUZAK, MIJDRECHT (NL); Frank NIJDAM, HARDERWIJK (NL)

(21) Appl. No.: 18/838,901

(22) PCT Filed: Feb. 14, 2023
(86) PCT No.: PCT/EP2023/053633

§ 371 Date: Aug. 15, 2024

(30) Foreign Application Priority Data
Feb. 16, 2022 (NL) 2030958

(51) Int. Cl. F16B 41/00; F16B 35/06

(52) U.S. Cl. CPC F16B 41/002; F16B 35/06

(57) ABSTRACT

A spring clip adapted to be arranged in an elongate through hole in a wall of a structural member for pre-assembling a T-bolt and the structural member. The spring clip has an elongate spring leaf and at each end of the spring leaf a connection arm. Each connection arm has a proximal end that is connected to the spring leaf and a distal end. At the distal end a support wing is connected to the connection arm.

### FIELD OF THE INVENTION

The field of the invention relates to spring clips used to pre-assemble a T-bolt to a structural member having an elongate through hole in its wall. The structural member may be a thin-walled hollow profile or rail, preferably made of metal. The elongate through hole may be a rectangular hole with straight transverse end edges, but may also be a slotted hole, which has circular end edges.

### BACKGROUND ART

U.S. Pat. No. 1,985,333 shows a more or less resilient clip made of a strip of sheet metal for mounting a T-bolt to an apertured wall. The clip has a center portion which is arched or bent correspondingly to the top curvature of the bolt head with end portions projection laterally. The curvature of the clip is formed of a slightly lesser radius than that of the curved top of the bolt head, and the clip is snapped in position over the bolt head before inserting these two now assembled parts through a wall aperture. This leaves the projecting ends resting against the outer surface of the wall at either end of the aperture, while the bolt head is now positioned in a sort of cage inside the wall with a threaded stem portion projecting outwardly. Thereafter the bolt is turned axially through a 90° angle. The curved arch portion of the clip frictionally holds the bolt in its turned position.

CN 105201965 shows a plastic clip for mounting a T-bolt to an apertured wall. The plastic clip is assembled with a bolt head of the T-bolt before the assembly is inserted through an aperture in the wall. The clip has swivelling legs which extend outwardly, the legs have end portions to lie on an outside surface of the wall. Pressure of the bolt head on inclined lugs connected with the legs swivels the legs towards each other which facilitates insertion in the aperture. After the bolt head is turned around 90°, the legs swivel outwardly and the end portions engage the outside surface of the wall. Rotation back of the bolt head is blocked by the inclined lugs.

### SUMMARY OF THE INVENTION

The invention relates to a spring clip adapted to be arranged in an elongate through hole in a wall of a structural member, said spring clip having an elongate spring leaf, at each end of the spring leaf a connection arm that has a proximal end that is connected to the spring leaf and a distal end, wherein at the distal end a support wing is connected to the connection arm, wherein the support wings extend in a common plane remote from the spring leaf, and wherein the spring leaf is curved having a convex side facing towards the common plane of the support wings.

In use the spring leaf is inserted through the hole in the wall of the structural member, while the support wings extend beyond the end edges of the hole. The spring leaf is inserted until the support wings rest on outer wall surface portions adjacent the end edges. Next a T-bolt having a transverse head can be inserted in the elongate hole. The transverse head of the T-bolt is aligned with the elongate hole and inserted in the through the hole. The head of the T-bolt is pushed against the spring leaf such that the spring leaf deforms and is tensioned. The T-bolt is then rotated around the central axis of its shaft, such that the head of the T-bolt is misaligned with the elongate hole and engages beyond lateral edges of the elongate hole. When the T-bolt is released the spring clip biases the head against an inside surface of the wall lateral of the elongate hole. The spring clip thus provides a convenient preliminary mounting state for the T-bolt. The user can let go of the bolt to take up other parts that have to be mounted to hollow profile by the bolt. Moreover, the spring clip prevents that the T-bolt can fall into the hollow profile.

The support wings extend in a common plane remote from the spring leaf. Thus the support wings can rest flat against a flat outer surface of the hollow profile, while the spring leaf is sunk into the elongate hole.

The spring leaf is curved having a convex side facing towards the common plane of the support wings. In a mounted state of the spring clip the convex side of the spring leaf is thus facing the hole. A T-bolt head that is inserted through the hole is pushed against the convex side of the spring leaf which is deformed such that a biasing spring action is induced. This design warrants that the spring clip can cooperate with T-bolt heads within a certain range of dimensions, e.g. a range of heights or a range of longitudinal or transversal (width) dimensions. The spring clip according to the invention is thus more universally usable than the known solutions from U.S. Pat. No. 1,985,333 and CN 105201965, in which the shape and size of the clip and the T-bolt head must be closely matched to ensure a proper engagement and cooperation between the two.

The spring clip according to the invention provides is a very simple and easy to make part. In a preferred embodiment the spring clip is made in one piece, preferably by bending an originally straight and flat strip of sheet metal. The spring clip is preferably formed from a strip having a constant width, which is convenient to make as a blank before bending takes place. No cutting of complex contours is necessary.

In an embodiment the support wings are aligned. This makes the spring clip a simple product which can be easily made by bending an originally straight and flat strip of sheet metal.

It is also conceivable to make the spring clip in one piece from plastic, preferably by injection moulding.

In an embodiment the connection arms extend substantially transverse to the support wings. The connection arms bridge the distance between the support wings and the spring leaf, such that the spring leaf can be sunk in the profile through the elongate hole.

The connection arms may comprise multiple arm portions, which extend under an angle relative to each other. Preferably the multiple arm portions include a first arm portion that extends substantially perpendicular from the end of the spring leaf, and a second arm portion that extends substantially perpendicular from the support wing. More preferably the first arm portions extend in a tapering manner seen in the direction towards the spring leaf. This tapering shape allows guided insertion of the spring clip in the elongate through hole, while connection arms are pushed automatically towards each other by the end edges of the hole.

In a further embodiment the first arm portion and second arm portion are connected by a substantially Z-shaped intermediate arm portion. The Z-shaped intermediate portion allows a snap connection between the spring clip and the hole in the hollow profile. The spring clip is literally snapped in the elongate through hole, and is retained there by the snap action. The tapering first arm portions are pushed towards each other by the end edges of the hole, as is mentioned above. This tensions the connection arms which are resilient. When the Z-shaped intermediate portions move beyond the end edges of the hole, the connection arms snap outward and engage with a portion of the Z-shaped portions beyond the respective end edges. The spring clip is now locked in the hole and cannot fall out.

The spring clip according to the invention is preferably a bent part made of a strip of sheet metal, preferably stainless steel, more preferably stainless spring steel.

However, in another embodiment the spring clip is made of plastic, preferably injection moulded.

The invention also relates to a combination of a spring clip as described in the above and a thin-walled constructional member comprising a wall having least one elongate through hole in said wall, the through hole having a length L and a width W which is smaller than said length L, and wherein the spring clip has a width that is slightly smaller than the width of the through hole and wherein the distance between the support wings of the spring clip approximately corresponds to the length L of the through hole.

The thin-walled constructional member may be a hollow profile.

The invention also relates to an assembly of a combination of a spring clip and a thin-walled constructional member as mentioned above, and furthermore comprising a T-bolt.

Another aspect of the invention relates to a spring clip adapted to be arranged in an elongate through hole in a wall of a structural member, said spring clip having an elongate spring leaf, at each end of the spring leaf a connection arm that has a proximal end that is connected to the spring leaf and a distal end, wherein at the distal end a support wing is connected to the connection arm.

The spring clip according to this aspect of the invention can at least be combined with the features of the dependent claims 2-15, or with features described in the description.

The invention also relates to a method for mounting a T-bolt to a thin-walled constructional member comprising a wall having least one elongate through hole in said wall, including the following method steps:
arranging a spring clip as described in the above in said through hole in the wall of the constructional member,
aligning a transverse head of the T-bolt with the elongate hole and inserting the head through the hole,
pushing the head of the T-bolt against the spring leaf such that the spring leaf deforms and is tensioned,
rotating the T-bolt around its central axis, such that the head of the T-bolt is misaligned with the elongate hole and engages beyond lateral edges of the elongate hole,
releasing the T-bolt, such that the spring clip biases the head against an inside surface of the wall lateral of the elongate hole.

The invention also relates to a method for manufacturing a spring clip, wherein an originally straight and flat strip of sheet metal and having a constant width is bent to form:
an elongate spring leaf,
at each end of the spring leaf a connection arm that has a proximal end that is connected to the spring leaf and a distal end,
a support wing connected to the distal end of the connection arm.

The invention will be further elucidated in the following description with reference to the drawings.

### BRIEF DESCRIPTION OF THE DRAWINGS

FIG. 1 shows in a view in perspective an embodiment of a spring clip according to the invention,

FIGS. 2 and 3 illustrate in a view in perspective and in a front view, respectively, the spring clip of FIG. 1 being arranged in a hole in a hollow profile and a T-bolt is inserted in the hole,

FIG. 4 illustrates in a cross section the head of the T-bolt being inserted through the hole in the profile,

FIG. 5 illustrates in a cross section the T-bolt of FIG. 4 being turned over 90 degrees, and

FIGS. 6-8 illustrate the T-bolt in a preliminary mounting state in the profile wall by means of the spring clip of FIG. 1.

### DETAILED DESCRIPTION

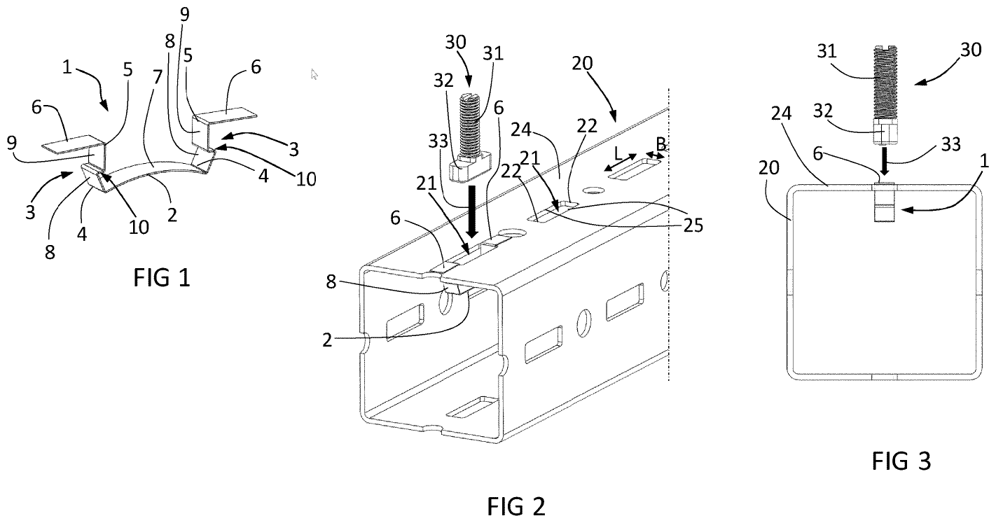

FIG. 1 shows a spring clip 1. This particular spring clip is a made by bending an initially flat strip of sheet metal having a constant width. The strip of sheet metal is preferably of stainless steel, more preferably of stainless spring steel.

In manufacturing the spring clip 1, no cutting of a contour of the strip takes place. The original strip, having a constant width, only has to be cut to the required length. Thereby it is a very easily and cost effectively producible part.

The spring clip 1 has an elongate spring leaf 2. At each end of the spring leaf a connection arm 3 is formed that has a proximal end 4 that is connected to the spring leaf 2. Each connection arm 3 furthermore has a distal end 5, where a support wing 6 is connected to the connection arm 3.

The support wings 6 extend in a common plane remote from the spring leaf 2 and are aligned. The spring leaf 2 is curved having a convex side 7 facing towards the common plane of the support wings 6. The connection arms 3 bridge the distance between the support wings 6 and the spring leaf 2.

The connection arms 3 extend substantially transverse to the support wings 6. The connection arms 3 comprise multiple arm portions including a first arm portion 8 that extends substantially perpendicularly from the end of the spring leaf 2, and a second arm portion 9 that extends substantially perpendicularly from the support wing 6, as is shown in FIG. 1. As the spring leaf is curved the first arm portion 8 and the second arm portion 9 extend under an angle relative to each other. The first arm portions 8 extend in a tapering manner seen in the direction towards the spring leaf 2. The first arm portion 8 and the second arm portion 9 are connected by a substantially Z-shaped intermediate arm portion 10.

In FIGS. 2 and 3 is shown that the spring clip 1 is arranged in an elongate through hole 21 in a hollow profile 20. The elongate through hole 21 is in this example a rectangular hole with straight transverse end edges. However the spring clip 1 can also be used with a slotted hole, which has circular end edges, which are typically made in walls of hollow profiles, such as for example in bottom and lateral walls of mounting rails. The spring clip 1 can essentially be used with any structural member having a through hole 21.

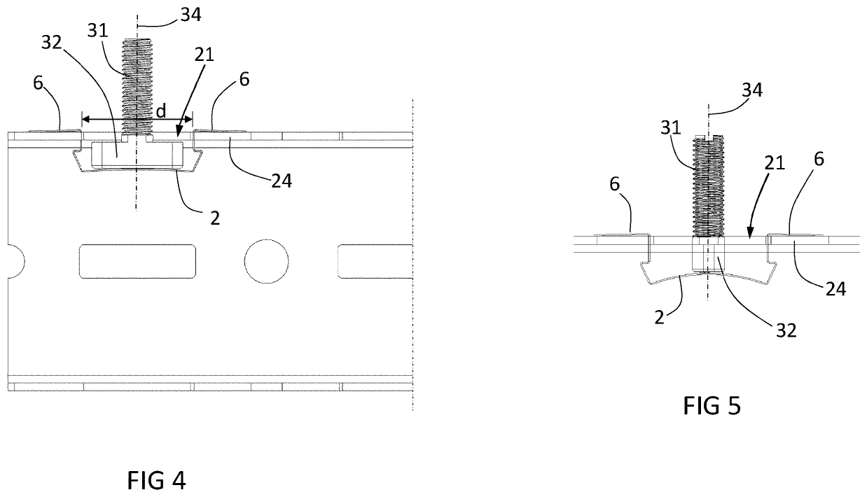

The through hole 21 has a length L (see FIG. 2) and a width W (see FIG. 2) which is smaller than said length L. The spring clip 1 has a width that is slightly smaller than the width W of the through hole 21. The distance d (see FIG. 4) between the support wings 6 of the spring clip 1 approximately corresponds to the length L of the through hole 21.

The spring leaf 2 is inserted through the hole 21 in the wall 24 of the hollow profile 20. The support wings 6 extend beyond the end edges 22 of the hole 21. The spring leaf 2 is inserted until the support wings 6 rest on outer wall surface portions adjacent the end edges 22.

A T-bolt 30 having a shaft 31 and a transverse head 32 can be inserted with the head 32 in the elongate hole 21 as is indicated in FIGS. 2 and 3 with an arrow 33. The spring clip 1 prevents that the T-bolt can fall into the hollow profile 20. The transverse head 32 of the T-bolt 30 is aligned with the elongate hole 21 and inserted in the hollow profile 20 through the hole 21. The head 32 of the T-bolt 30 is pushed against the convex side 7 of the spring leaf 2 such that the spring leaf 2 deforms and is tensioned. This is illustrated in FIG. 4, where the spring leaf 2 by way of illustration is deformed to a substantially flat shape by the pressure of the T-bolt head 32.

When the T-bolt head 32 is sunk into the hole 21 and is moved beyond the wall 24, the T-bolt 30 can be rotated around the central axis 34 of the shaft 31. By the rotation the head 32 of the T-bolt 30 is misaligned with the elongate hole 21 and engages the inside of the wall 24 beyond lateral edges 25 of the elongate hole 21. When the T-bolt 30 is released by the user, the spring leaf 2 takes a curved shape again and thereby the spring clip 1 biases the T-bolt head 32 against an inside surface of the wall 24 lateral of the elongate hole 21, thus next to the lateral edges 25. This is illustrated in FIG. 5.

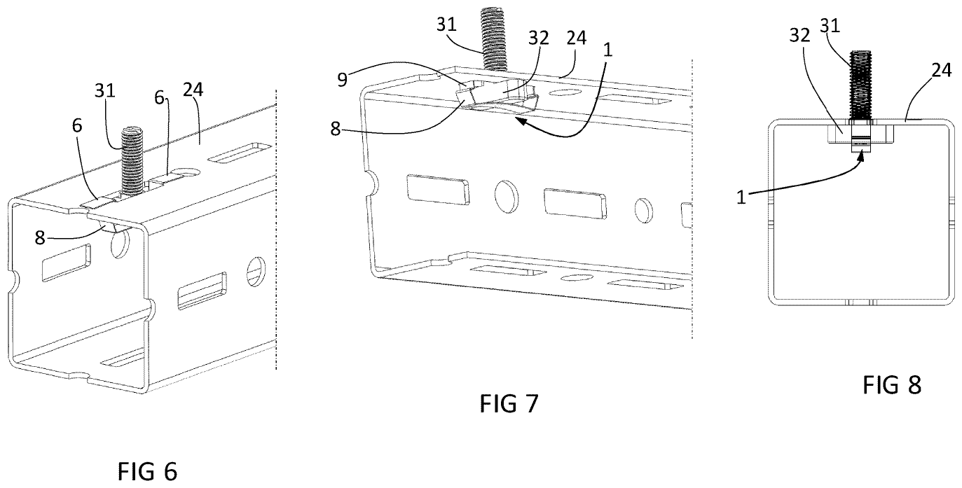

By the biasing force of the tensioned spring leaf 2, the spring clip 1 holds the T-bolt 30 in the preliminary mounting state, which is further illustrated in FIGS. 6-8. The user can let go of the T-bolt 30 to take up other parts that have to be mounted to hollow profile 20 by means of bolt 30.

1. A spring clip adapted to be arranged in an elongate through hole in a wall of a structural member, said spring clip having an elongate spring leaf, at each end of the spring leaf a connection arm that has a proximal end that is connected to the spring leaf and a distal end, wherein at the distal end a support wing is connected to the connection arm, wherein the support wings extend in a common plane remote from the spring leaf, and wherein the spring leaf is curved having a convex side facing towards the common plane of the support wings.

2. The spring clip according to claim 1, wherein the spring clip is made in one piece.

3. The spring clip according to claim 2, wherein the spring clip is made by bending an originally straight and flat strip of sheet metal.

4. The spring clip according to claim 2, wherein the spring clip is made of a metal strip having a constant width.

5. The spring clip according to claim 1, wherein the support wings are aligned.

6. The spring clip according to claim 1, wherein the connection arms extend substantially transversely to the support wings.

7. The spring clip according to claim 1, wherein the connection arms comprise multiple arm portions, which extend under an angle relative to each other.

8. The spring clip according to claim 7, wherein the multiple arm portions include a first arm portion that extends perpendicularly from the end of the spring leaf, and a second arm portion that extends perpendicularly from the support wing.

9. The spring clip according to claim 8, wherein the first arm portions extend in a tapering manner seen in the direction towards the spring leaf.

10. The spring clip according to claim 8, wherein the first arm portion and second arm portion are connected by a substantially Z-shaped intermediate arm portion.

11. The spring clip according to claim 1, wherein the spring clip is a bent part made of a strip of stainless steel.

12. The spring clip according to claim 1, wherein the spring clip is made of plastic.

13. A combination of a spring clip according to claim 1, and a thin-walled constructional member comprising a wall having least one elongate through hole in said wall, the through hole having a length L and a width W which is smaller than said length L, and wherein the spring clip has a width that is slightly smaller than the width of the through hole and wherein the distance between the support wings of the spring clip approximately corresponds to the length L of the through hole.

14. The combination according to claim 13, wherein the thin-walled constructional member is a hollow profile.

15. An assembly of a combination according to claim 13, and furthermore comprising a T-bolt.

16. A method for mounting a T-bolt to a thin-walled constructional member comprising a wall having least one elongate through hole in said wall, including the following method steps:
arranging a spring clip according to claim 1, in said through hole in the wall of the constructional member,
aligning a transverse head of the T-bolt with the elongate hole and inserting the head through the hole,
pushing the head of the T-bolt against the spring leaf such that the spring leaf deforms and is tensioned,
rotating the T-bolt around its central axis, such that the head of the T-bolt is misaligned with the elongate hole and engages beyond lateral edges of the elongate hole,
releasing the T-bolt, such that the spring clip biases the head of the T-bolt against an inside surface of the wall lateral of the elongate hole.

17. A method for manufacturing a spring clip, wherein an originally straight and flat strip of sheet metal and having a constant width is bent to form:
an elongate spring leaf,
at each end of the spring leaf a connection arm that has a proximal end that is connected to the spring leaf and a distal end,
a support wing connected to the distal end of the connection arm wherein the support wings extend in a common plane remote from the spring leaf, and wherein the spring leaf is curved having a convex side facing towards the common plane of the support wings.

18. The spring clip according to claim 1, wherein the spring clip is a bent part made of a strip of stainless spring steel.
